(19) United States
(12) Patent Application Publication
(10) Pub. No.: US 2025/0179860 A1
(43) Pub. Date: Jun. 5, 2025

(54) METHOD FOR MONITORING AN AUTOMATIC DOOR SYSTEM AS WELL AS SYSTEM WITH AN AUTOMATIC DOOR SYSTEM

(71) Applicant: Assa Abloy Entrance Systems AB, Landskrona (SE)

(72) Inventor: Marco HAURI, Galgenen (CH)

(21) Appl. No.: 18/685,945

(22) PCT Filed: Aug. 31, 2022
(86) PCT No.: PCT/EP2022/074180

§ 371 Date: Feb. 23, 2024

(30) Foreign Application Priority Data
Aug. 31, 2021 (SE) 2130233-6

(51) Int. Cl. E05F 15/73; G06T 7/00; G06T 7/70; G06V 10/774; G06V 10/82; G06V 20/52; H04N 7/18

(52) U.S. Cl. CPC E05F 15/73; G06T 7/0002; G06T 7/70; G06V 10/774; G06V 10/82; G06V 20/52; H04N 7/183; E05F 2015/767; G06T 2207/10016; G06T 2207/20081; G06T 2207/20084; G06T 2207/30232

(57) ABSTRACT

A method for monitoring an automatic door system (14) using a monitoring unit (12) is provided. The door system (14) comprises a movable door leaf (20), at least one drive unit (38), a camera (40) and a control unit (36) for controlling the drive unit (38) based on the recordings generated by the camera (40). The method comprises the following steps:—capturing at least one recording by the camera (40), wherein the recording includes at least parts of the door component (18),—determining a state of the door system (14) based on the transmitted recording, and—determining a remaining useful life and/or a need for servicing the door system (14) based on the determined state of the door system (14). Further, a system (10) is shown.

The invention is directed to a method for monitoring an automatic door system as well as a system with an automatic door system.

Automatic door systems are known and provide controlled access to buildings, mostly commercial buildings. The automatic door systems may also provide critical functions with respect to escape routes, fire-safety and smoke doors.

The intervals in which a service or maintenance of the door systems is carried out depend on regulatory requirements and the opening cycles a door has performed. However, these parameters to not predict the times for a service realistically and cannot take into account unexpected events.

Thus, it is an object of the invention to provide a method for monitoring an automatic door system that improve the prediction concerning the point in time at which a door systems has to be serviced.

For this purpose, a method for monitoring an automatic door system using a monitoring unit is provided. The door system comprises at least one door component, in particular a movable door leaf, at least one drive unit for actuating the at least door component, a camera and a control unit for controlling the drive unit based on the recordings generated by the camera The method comprises the following steps:
capturing at least one recording by the camera, wherein the recording includes at least parts of the door component,
transmitting the recording to the monitoring unit,
determining a state of the door system based on the transmitted recording by the monitoring unit, and
determining a remaining useful life and/or a need for servicing the door system based on the determined state of the door system.

The inventors have realized that the state of wear and in turn the remaining useful lifetime and/or the need for servicing the door system can be determined based on the recordings of a camera.

By predicting the state of the door system as well as the remaining useful lifetime and/or the need for servicing the door, it is possible to improve the prediction of the optimal time for a service. Further, unexpected events can also be considered for scheduling a service.

The recording includes in particular at least parts of the door component if the camera is in the correctly assembled position.

The door may be a swing door, a revolving door, a sliding door, a folding door or the like. The door may comprise a door leaf, which is driven by the drive unit.

In an aspect, the camera is an integral part of the safety functionality of the door and monitors the track of the door, particularly of the door leaf and/or the camera is a camera based opening sensor, i.e. the sensor which is used to activate the door if persons are approaching the door. This way, the number of parts necessary to manufacture the system may be reduced.

In particular, the camera may be mounted above the door. The camera may be a camera based sensor of the door.

The recording may include parts of the track of the door component and an area of up to 5 m, preferably up to 7 m, more preferably still up to 10 m (measured on the ground) in front of the door.

The monitoring unit may be part of the door system, in particular a part of the control unit or a controller of the camera of the door system, or the monitoring unit may be separate from the door system, for example provided as a cloud server or a mobile device, which is not permanently close to and/or connected to the door system.

For example, if the remaining useful life below a predetermined threshold and/or a need for servicing the door system has been determined by the monitoring unit, measures are taken or initiated by the monitoring unit, in particular the control unit is ordered to change the actuation of the door system to increase the remaining useful life and/or a door service may be initiated, for example by informing a service technician. This way, the door system may receive the service automatically when it is needed.

The service technician may be informed by advising a mobile device or computer of the service technician, by controlling visual indicators of the door system, for example LEDs, and/or by an IoT-network or on the display of the mode-of-operation terminal, i.e. a terminal at the door at which the operation mode of the door system can be set.

The remaining useful life may be documented into a log-file and/or displayed on the terminal.

In an embodiment of the invention, the at least one door component is a movable door leaf and/or a protective wing, in particular wherein the door system comprises two or more movable door leafs and the recording includes the door leafs at least partially, in particular entirely. Thus, the door leaf-being a component prone to wear—can be monitored.

In an aspect of the invention, the state of the door system is a state of wear, a maintenance state and/or the presence of an irregularity so that various influences on the need for service and/or the remaining useful lifetime can be taken into consideration.

For example, the state of wear includes damages of the door component and/or parts of the door component, in particular damages, detachment, misplacement and/or changes to seals, brushes, profiles, window panes, protection devices and/or panels of the door system. Thus, the wear of the door system may be evaluated and damaged parts or components may be replaced early.

The protection device may be a pinch zone protection or a protection profile, that ensures the safety of certain parts.

In another aspect, the maintenance state includes the clearance, the presence of a protective wing, the position of the protective wing, the presence of a protection device, the position of the protection device, the presence of a protective profile, and/or the position of the protective profile. This way, misalignments and malfunction that occur during the lifetime of a door system can be detected and evaluated.

In order to consider unforeseen events, the determined irregularities may include the absence of the door component in the recording, vibrations during movement of the door and/or of the component, an emergency stop and/or an obstacle in a track of the door system or at the ground.

For example, the recording is a recording of a single image, a series of images and/or a video sequence.

The images of the series of image are preferably consecutive.

In an embodiment, the state of the door system is determined by a comparison of the recording with a reference recording, in particular wherein the reference recording has been captured immediately after the first installation of the door system, after a major service of the door system, recorded at a previous point in
time, is generated by the manufacturer and/or has been generated on the basis of many different recordings that have been captured with a certain time difference. By providing a reference recording, the desired and optimal state of the door system is set reliably.

The reference recording may be stored in the monitoring unit.

By using the reference recording, deposition of dirt, graffiti or the like can be detected. Furthermore, certain environmental influences will not negatively affect the predictions as the reference is known.

In an embodiment of the invention, the state of the door system is determined by comparing multiple images of the recording with one another, in particular by comparing a plurality of images of a video sequence. This way, the motion of the door component can be taken into account for the determination.

The multiple image may be recorded consecutively and/or are from different recordings.

In an aspect of the invention, the state of the door system is determined by the following steps:
recognizing an object in the images of the recording and its coordinate within each image;
determining the change of coordinates of the object over the course of at least two images, and optionally determining a vibration, movement and/or strain of the object by comparing the coordinates of the object of each image, in particular wherein the presence of an irregularity, like an obstacle in the track, is determined if the movement of the object is non-uniform and/or if vibrations are present.

By comparing the changes on the coordinate level, even small deviations from the optimal operation are detectable.

The object may be any part or component of the door system, for example the door component, one or both door leafs, the protective wing, the protection device, one of the seals, one of the brushes, one of the profiles, one of the window panes and/or one of the panels.

In order to further increase the accuracy of the determination of the state of the door system, the remaining useful life and/or the need for servicing the door system may comprise at least one sensor transmitting at least one measurement value to the monitoring unit, wherein the state, the remaining useful life and/or the need for servicing the door system is also determined based on the at least one measurement value.

In particular, the sensor is a non-optical sensor.

For example, the sensor is a vibration sensor, an acceleration sensor for determining the transversal acceleration on the door leaf and/or a microphone for airborne noise and/or structure-borne noise. These sensors have been proven to supplement the information of the camera efficiently.

In another embodiment, the drive unit and/or the control unit measure at least one further measurement value and transmit the at least one further measurement value to the monitoring unit, wherein the at least one further measurement value is used for determining the state, the remaining useful life and/or the need for servicing the door system, in particular wherein the at least one further measurement value is one or more value of the following group: motor current; temperature of the motor and/or of a battery of the drive unit; health of the battery of the drive unit; voltage and current patterns on the motor operator of the drive unit; power consumption for performing a full closing cycle; change in mass inertia of the door; usage patterns and kinematics resulting from usage patterns; exceptional usages, in particular emergency stops; and signals of a communication bus.

By taking information from the control unit and/or the drive unit into consideration, the determination of the state of the door system, the remaining useful life and/or the need for servicing is improved further.

Further improvements on the determination of the state of the door system, the remaining useful life and/or the need for servicing are achievable if the monitoring unit receives further information, wherein the information is used for determining the state, the remaining useful life and/or the need for servicing the door system, in particular wherein the further information include weather data, like wind speed, wind direction, humidity and/or ambient temperature; information about services performed at the door system; and/or information from a system of the building the door system in installed in, for example a temperature of an air conditioning system of the building.

In a further aspect of the invention, the monitoring system may determine the cause for the state of the door system, in particular the deterioration of the state, in particular wherein the cause may be severe and/or enduring weather conditions, vandalism, misuse, emergency stops and/or accidents.

The cause for the state of the door may be determined in the same way as the state of the door, in particular simultaneously.

In an embodiment of the invention, the determination of the state of the door system, of the cause for the state of the door, of the remaining useful life and/or of a need for servicing is performed by a deterministic algorithm, a machine learning algorithm, a support vector machine and/or a trained artificial neural network of the monitoring unit. This way, the accuracy of the determination is high.

To achieve optimal results, the artificial neural network may be trained using training data, wherein the training data comprises, for various training situations, input data of the same type and structure as the data which is fed to the artificial neural network during regular operation of the door system, and information about the expected correct output of the artificial neural network for the training situations; the training comprises the following training steps:
feed forward of the input data through the artificial neural network;
determining an answer output by the artificial neural network based on the input data,
determining an error between the answer output of the artificial neural network and the expected correct output of the artificial neural network; and
changing the weights of the artificial neural network by back-propagating the error through the artificial neural network,
   in particular wherein the input data includes recordings generated by the camera, the at least one measurement value of the at least one sensor, the control unit and/or the drive unit and/or further information receivable by the monitoring unit; wherein the information about the expected correct output includes the state of the door system, the remaining useful life and/or the need for servicing the door system in the training situations; and wherein the answer output includes the state of the door system, the remaining useful life and/or the need for servicing determined based on the input data.

For above purpose, a system is further provided comprising a monitoring unit and an automatic door system having at least one door component, in particular a movable door leaf, at least one drive unit for actuating the at least door component, a camera having a field of view including at least parts of the door component, and a control unit for controlling the drive unit based on the recordings generated by the camera, wherein the system is configured to carry out a method a explained above, in particular wherein the monitoring unit is part of the door system, for example the control unit.

The features and advantages discussed with respect to the method also apply to the system and vice versa.

Further features and advantages will be apparent from the following description as well as the accompanying drawings, to which reference is made. In the drawings

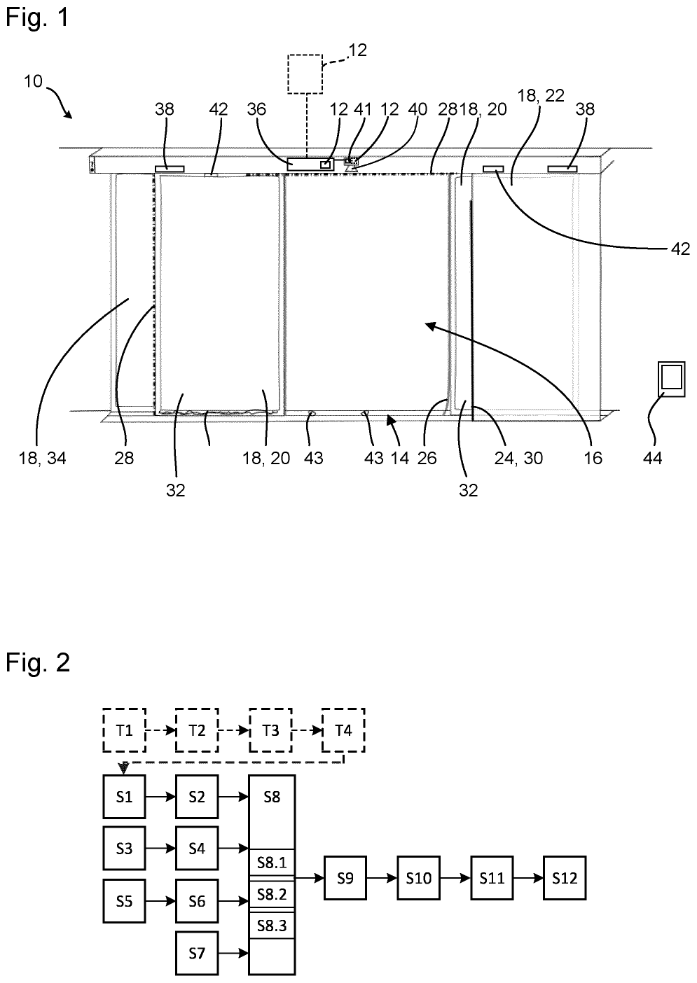

FIG. 1: shows a system according to the invention schematically,

FIG. 2: shows a flowchart of a method according to the invention,

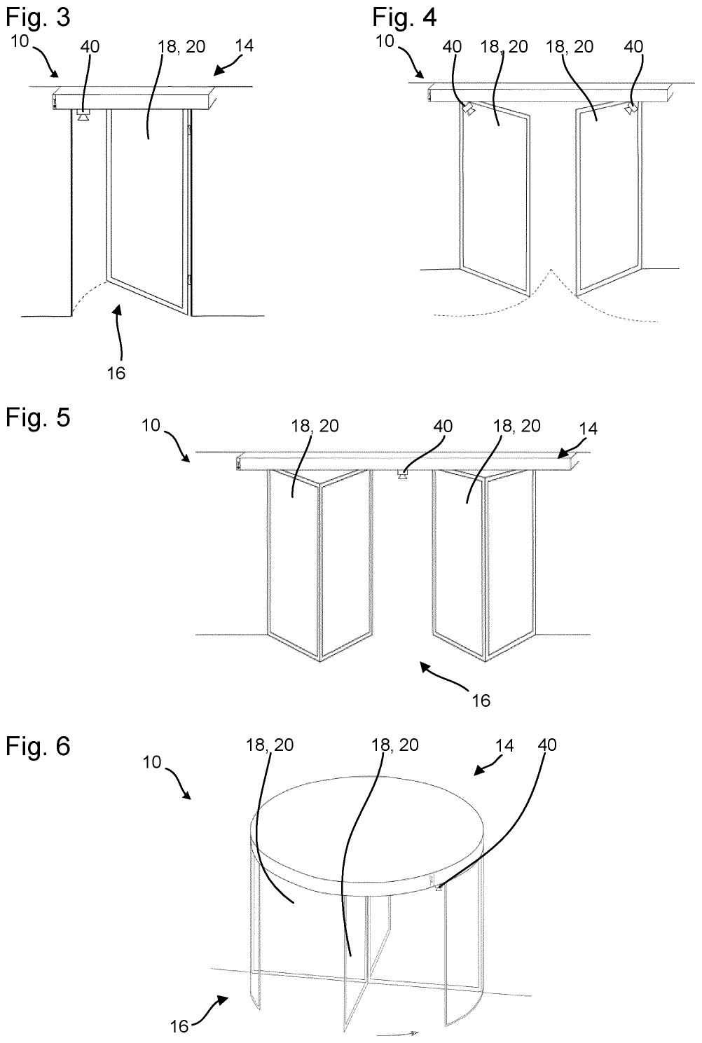

FIG. 3, 4: show a second and a third embodiment of a system according to the invention having an automatic door system with the door being a swing door having one or two door leafs, respectively,

FIG. 5: shows a fourth embodiment of a system according to the invention having an automatic door system with the door being a foldable door, and

FIG. 6: shows a fifth embodiment of a system according to the invention having an automatic door system with the door being a revolving door.

FIG. 1 shows schematically a system 10 having a monitoring unit 12 and an automatic door system 14.

The automatic door system 14 has a door 16 being a slidable door in the embodiment shown in FIG. 1. The door 16 comprises various door components 18, namely two door leafs 20, a protective wing 22, and a protection device 24, like a protective profile.

The door leafs 20 or other door components 18 may have seals 26, brushes 28, profiles 30, window panes 32 and/or panels 34 as known in the art.

The automatic door system 14 further comprises a control unit 36, two drive units 38, a camera 40 and a sensor 42.

The camera 40, the sensor 42 and the drive units 38 are connected to the control unit 36.

The control unit 36 is configured to control the drive units 38.

Each of the drive units 38 is associated with one of the door leafs 20 and is designed to move the respective door leaf 20 along a track.

The camera 40 has a controller 41 and is located above the door 16 and has a field of view that includes at least parts of one or more of the door components 18.

Further, the field of view F of the camera 40 may cover an area of up to 5 m, preferably up to 7 m, more preferably still up to 10 m in front of the door 16, measured on the ground.

The sensor 42 is, for example, a non-optical sensor.

The sensor 42 may be a vibration sensor, an acceleration sensor for determining the transversal acceleration on the door leaf 20 and/or a microphone for airborne noise and/or structure borne noise.

The monitoring unit 12 may also be a part of the automatic door system 14. For example, the monitoring unit may be integrated into the control unit 36 or integrated into the controller of the camera 40. A monitoring unit 12 as part of the camera 40 is indicated with dotted lines in FIG. 1.

It is also conceivable that the monitoring unit 12 is separate from the door system 14. In this case, the monitoring unit 12 may be provided as a cloud server (shown in dashed lines in FIG. 1) or as a mobile device 44, which is not is not permanently close to and connected to the door system 14.

For monitoring the door system 14 the method illustrated as a flowchart in FIG. 2 is carried out.

The method relies primarily on recordings captured by the camera 40. The camera 40, more precisely the recording of the camera 40 also serve other functions.

For example, the camera 40 is also an integral part of the safety function of the door system 14. Namely, the camera 40 monitors the track of the door 16, i.e. the movement path of the door leafs 20, and forwards this information to the control unit 36 or its integrated controller. Based on this information, the integrated controller and/or the control unit 36 control the drive units 38 to ensure that the door 16 is operated safely. In particular, to avoid that persons, in particular children, present in the track of the door 16 are harmed by the door leafs 20.

Further, the camera 40 may also be regarded as a camera based opening sensor, i.e. the sensor which is used to activate the door 16 if persons are approaching the door 16 and/or a camera based safety sensor, i.e. the sensor which is used to safeguard the danger zones of the automatic door 16.

In a first step S1 of the method according to the invention, a recording is captured by the camera 40.

The recording may be a single image, a senes of images, for example consecutive images, and/or a video sequence.

As the field of view of the camera (in the correctly set-up and aligned position) includes also the door 16 and door component 18, the recording also includes at least parts of the door component 18, for example the door leafs 20 and the protective wings 22.

For example, the door leafs 20 and/or the protective wings 22 are entirely visible in the recording, at least in the closed state of the door 16.

The recording is then, in step S2, transmitted to the monitoring unit 12.

In case that the monitoring unit 12 is part of the automatic door system 14, the transmission is done via cables.

In case of a monitoring unit 12 separate from the automatic door system 14, i.e. as part of a cloud service or being a mobile device sporadically connected to the door system 14, the transmission is carried out, for example, wirelessly using known data communication standards like Bluetooth or WLAN. It is of course possible, that the automatic door system 14 is connected via a cable to the mobile device serving as the monitoring unit 12 or to a cable network, communication bus of the building or the internet to establish a connection to the remote monitoring unit 12.

In addition, the recording may be stored in the automatic door system 14, for example in the control unit 36.

Further, in case the automatic door system 14 is equipped with a further sensor 42, the sensor 42 may, in step S3, perform a measurement obtaining a measurement value.

For example, the measurement may be, depending on the sensor 42, a vibration measurement, an acceleration measurement measuring the transversal acceleration on each of the door leafs 20 and/or an acoustic measurement of airborne noise or structure borne noise during the movement of the door leafs 20.

The measurement value is then, in step S4, also transmitted to the monitoring unit 12. This transmission may be performed in the same manner as the transmission of the recording.

The measurement value may also include or is supplemented by information correlating the measurement values to the movement and/or position of the door leafs 20. This information may be added by the drive unit 38 or the control unit 36.

The drive unit 38 and the control unit 36 also perform measurements during operation of the automatic door system 14, in particular during actuation of the door leafs 20.

Thus, the drive unit 38 and the control unit 36 also obtain measurement values (step S5) which are transmitted to the monitoring unit (step S6). This may be done in the same way as the transmission of the recording and the measurement values of the sensors 42.

The measurement values obtained by the control unit 36 and/or the drive unit 38 may be the motor current of a motor for actuating one of the door leafs 20, the temperature of the motor, the temperature of a battery of the drive unit 38, the health of the battery and/or voltage patterns of the motor operator of the drive unit 38.

The measurement values may also be more complex information like the power necessary to perform a full closing cycle, i.e. to close both door leafs 20 and open them fully again. Also the change in mass inertia of the door, usage patterns and kinematics resulting from the usage patterns may serve as measurement values.

Further, the occurrence of exceptional usages, for example emergency stops, which are very strenuous on the door leafs 20 and the door system 14 as a whole, are obtained by the control unit 36 and/or the drive unit 38 and serve as measurement values.

Moreover, signals received from a communication bus, for example a communication bus of a door system 14 and/or of the building, may be used as measurement values and transmitted to the monitoring unit 12.

In addition or alternatively, in step S7, the monitoring unit 12 may receive further information, for example weather data, like wind speed, wind direction, humidity and/or ambient temperature, information about services performed at the door system 14, and/or information from other systems of the building that the door system 14 is installed in. The other systems may be an air conditioning system informing the monitoring unit 12 about the current temperature and/or a desired temperature within the building.

The monitoring unit 12 may receive the further information from the automatic door system 14 or from other source independently from the automatic door system 14, for example using a separate Internet connection.

The capturing and transmitting of the recording (steps S1, S2), the measurements of the sensors 42 and the transmission of the measured values (steps S3, S4), the measurements by the control unit 36 and/or the drive unit 38 and the transmission to the monitoring unit 12 (steps S5, step S6) as well as the reception of the further information by the monitoring unit 12 (step S7) may be performed in any order and/or simultaneously.

Each of the steps S1 to S7 may be performed once, in regular intervals, on-demand or continuously, for example at the frame rate of the video sequence of the recording.

The information gathered in these steps S1 to S7 that are measured at the same point in time or correspond to the same point in time form a data set. On the basis of such a data set the state of the door system 14 is determined by the monitoring unit (step S8).

The monitoring unit 12 comprises a deterministic algorithm, a machine learning algorithm, a support vector machine and/or a trained artificial neural network.

The artificial neural network may be a multilayer perceptron (MLP), a convolutional neural network (CNN), a deep belief network (DBN), a Hamiltonian Neural Network (HNN), a Long Short-Term Memory (LSTM) network or a combination of two or more of these networks.

As the data sets may be generated in short succession, each data set may trigger a separate determination of the state of the door system 14 so that more than one processes for determining the state of the door system 14 may be performed by the monitoring unit 12 simultaneously.

The state of the door system 14 may be a state of wear of the door system 14, a maintenance state and/or the presence of an irregularity.

The state of wear of the door system 14 represents the overall deterioration of the door system 14 from its new state that has occurred due to abrasion, friction, weather influences and the like. Thus, the state of wear includes damages of the door components 18 and/or of parts of the door components.

This may include damages to, the detachment of, the misplacement of and/or changes to one or more of the seals 26, brushes 28, profiles 30, window panes 32 and/or panels 34 of the door system 14.

For example, scratches on the door leafs 20, e.g. its window panes 32 or panels 34, are indicators for a bad state of wear as well as brittle seals 26 or brushes 28.

The maintenance state of the door system corresponds to adjustable properties of the door, like the clearance between the door leafs 20 in the closed position of the door 16, the presence and position of the protective wing 22, the presence and the position of a protection device 24, like a pinch zone protection, and/or the presence and position of a protective profile.

For example, the clearance of the door 16 may easily be determined on the recordings. Even though an increase of the clearance is caused by wear, it is primarily an issue of configuring and setting up the door 16 properly. Thus, even though wear has occurred, during the next service the door properties may be adjusted so that the clearance is reduced, preferably without changing parts of the door 16.

Further, for example, during maintenance or cleaning, the protective wings 22, protection devices 24 or protective profiles are tilted or removed and may have not being replaced properly after the service has been completed. This failure may also be detected and is included in the maintenance state of the door system 14.

Moreover, an irregularity is a problem of the door 16 not included in the state of wear or the maintenance state as explained above.

Irregularities may include the absence of the door 16 or the monitored door component 18 in the recording. This occurs, for example, if the field of view of the camera 40 has been changed, e.g. by a physical force that has acted on the camera 40.

Further, unusual vibrations during the movement of the door leafs 20 or door components 18 may be an irregularity, as well as an emergency stop or an obstacle 43 in the track of the door leafs 20.

The determination of the state of the door is done based at least on the recording captured by the camera 40 and transmitted to the monitoring unit 12. It is of course conceivable, that the state of the door is also determined based on the measurement values received from the control unit 36, the drive unit 38 and/or the sensor 42.

In step S8.1, the monitoring unit 12, in particular the deterministic algorithm, the machine learning algorithm, the support vector machine and/or the trained artificial neural network, recognizes an object in the images of the recording and determines its coordinate within each of the images.

In other words, the position of the object, for example of the monitored door component 18 is determined exactly for each image, i.e. for each point in time.

The object may also be any part or component of the door system 14, for example one or both door leafs 20, the protective wing 22, the protection device 24, one of the seals 26, one of the brushes 28, one of the profiles 30, one of the window panes 32 and/or one of the panels 34.

Then, the change of the coordinates of the object over the course of at least two images, in particular the whole recording, is determined. Preferably, the movement of the object, for example the monitored door component 18 is determined.

Further, based on the change of coordinates, a vibration of and/or strain on the object, i.e. of the door component 18, can be determined. This can be achieved by comparing the coordinates of the respective object in each of the images.

For example, an obstacle 43 in the track of the door leafs 20, for example a small stone or stick, can be detected if the movement of the object is nonuniform and/or if vibrations are present. This indicates the presence of an irregularity.

Alternatively or in addition, in step S8.2, the monitoring unit 12 may determine the state of the door system by comparing a series of images from one or more recordings received from the camera 40. The images may be taken consecutively or spaced apart time wise. In particular, the chronological order of the images, preferably their exact point in time is known.

In particular, a plurality of images (frames) of a video sequence are compared to one another.

For example, by means of the comparison, the uniformity of the movement of the door leafs 20 (or any other monitored door component 18) may be evaluated.

It is also conceivable, that the movement of the door leafs 20 captured in the recording may be compared to the measurement values received from the drive unit, in particular those values indicating the intended movement of the door leaf 20, to determine whether the door leafs 20 behave as intended.

Alternatively or in addition, the monitoring unit 12, in particular the deterministic algorithm, the machine learning algorithm, the support vector machine and/or the trained artificial neural network, may determine the state of the door system 14 by performing a comparison of the recording transmitted from the camera 40 with a reference recording (Step S8.3)

The reference recording is a recording of the same type and contents as the recording transmitted from the camera, i.e. it is a recording taken from the same point of view as the recording from camera 40.

The reference recording may have been captured by the camera 40 immediately after the first installation of the door system 14, after a major service or at another point previous in time that should serve as a reference.

The reference recording may also be generated by the manufacturer by a camera of a sample door system of the same type.

It is also conceivable, that the reference recording has been generated on the basis of many different recordings of the camera that have been captured with a certain time difference.

The recording is stored in the monitoring unit 12 or on a server accessible by the monitoring unit 12 so that is available to the monitoring unit 12.

By way of comparison, the monitoring unit 12 might detected the position of dirt, graffiti or the like on the door components 18. Also, deterioration of the conditions of door components 18, like the occurrence of scratches, loss of parts or cracks in a window pane 32 can easily be detected by such a comparison.

Further, environmental influences will not negatively affect the determination of the state of the door, as the reference is known.

The course of the state of the door system 14 over time may be stored in the monitoring unit 12, or transmitted to the control unit 36 and/or to a computer of a facility maintenance system.

In step S9, the monitoring unit 12, in particular the deterministic algorithm, the machine learning algorithm, the support vector machine and/or the trained artificial neural network, determines the cause for the state of the door system, in particular if a deterioration of the state has occurred.

For example, the monitoring unit 12 determines based on the recording, the received measurement values and/or the received further information whether the deterioration of the state has occurred due to severe and/or enduring weather conditions, vandalism, misuse, emergency stops, side pressure induced door leaf bending and/or an accident, like a collision of the person and/or objects with one of the door component 18.

Based on the state of the door, the remaining useful life is determined by the monitoring unit 12, in particular by the deterministic algorithm, the machine learning algorithm, the support vector machine and/or the trained artificial neural network (step SIO).

Not only the captured recording but also the measurement values of the sensor 42, the measurement values of the control unit 36 and/or the drive unit 38 as well as the further information received by the monitoring unit 12 may be regarded for the determination of the state of the door system 14, its remaining useful life, the need for servicing the door system 14 and the causes therefore.

The remaining useful life indicates that the statistical remaining lifetime until the door system 14 needs to be replaced or fails. In other words, the remaining useful life indicates the availability of the door in the future.

This information is very important for critical applications such as escape routes, fire-safety and smoke doors. The knowledge of the remaining useful life in conjunction with automatically initiated countermeasures may make the need for redundancy in doors with critical functions obsolete.

The determined remaining useful life may be documented into a log file, either in the monitoring unit 12, the control unit 36 or a remote server.

In step S11, based on the determined state of the door and optionally on the determined remaining useful life, the monitoring unit, in particular the deterministic algorithm, the machine learning algorithm, the support vector machine and/or the trained artificial neural network, and determines the need for servicing the door system 14.

The need for servicing the door system 14 may include whether or not the door system 14 needs service as well as the urgency with which the service needs to be carried out. Further, this may also include the determination which door component 18 needs service and/or the tasks that need to be carried out during the service.

The need for service may be determined based on specific parameters, for example or a broken window pane 32 or if specific properties of the state of the door are outside given margins, like the clearance between the door leafs 20 in the closed position being too wide.

For example, a large clearance or minor scratches on the door leaf 20 indicate that the door system 14 is misaligned (maintenance status). Thus, there is a need to realign the door system 14 and therefore a need for service. However, as the overall functionality of the door system 14 is still available, the urgency of this need is low.

In another case, if it is detected that one of the window panes 32 is completely shattered so that persons could enter the building through the empty window frame, the urgency for servicing the door, i.e. replacing the window pane 32 is high.

The monitoring unit 12 takes or initiates measures as a response to the determined useful life and/or the determined need for service, in particular based on the state of the door (step S12).

Measures may be taken if the remaining useful life falls below a predetermined threshold and/or if specific service needs with a specific urgency are detected.

The measures may include that the control unit 36 is ordered by the monitoring unit 12 to change the actuation of the door system 14, for example by controlling the drive unit 38 such that the door leafs 20 are moved slower or with less acceleration in order to increase the remaining useful life.

Further, a measure may include to initiate a door service, for example by informing a service technician. This may be done by controlling a mobile device or a computer of the service technician, for example by sending notifications to his or hers mobile device or computer.

The notification may include the type of work that needs to be carried out, the urgency of the service and/or the replacement parts necessary for the service.

In addition or in the alternative, the service may be initiated by controlling visual indicators 46 of the door system 14, for example LEDs mounted above the door 16 and/or an a display of, for instance, the mode-of-operation selection terminal so that a service technician or a person of the facility maintenance is informed adequately.

Further, the door service may be initiated by an IoT network.

The artificial neural network of the monitoring unit 12 is an artificial neural network trained using training data.

The training data comprises sets of different input data for various situations and causes that may lead to a change of the state of the door, a change in the remaining useful life and/or a change in the need for service.

The input data includes the same type and data structure as supplied to the artificial neural network during the operation of the artificial neural network as explained above.

In particular, the input data includes the recordings generated by the camera 40, one or more measurement values of the at least one sensor 42, the control unit 36 and/or the drive unit 38, as well as further information receivable by the monitoring unit 12.

Further, the input data includes the expected correct output of the artificial neural network in response to each data set of the input data.

For the training of the artificial neural network, in a first training step T1 the input data is fed forward through the artificial neural network. Then, the answer output of the artificial neural network is determined (step T2).

The answer output may be the state of the door system, the cause for the state of the door system, the remaining useful life and/or the need for servicing of the door system that has been determined by the artificial neural network based on the input data for one of the various training situations.

In step T3, an error between the answer output of the artificial neural network and the expected correct output (known from the training data) is determined, in particular an error between the determined and the correct state of the door system, between the determined and correct cause of the state of the door system, between the determined and correct remaining useful life and/or between the correct and determined need for service.

In step T4, the weights of the artificial neural network are changed by back propagating the error through the artificial neural network.

By use of the monitoring unit, the automatic door system 14 may efficiently be monitored and countermeasures may be initiated automatically and very timely to reduce further deterioration of the state of the door.

For example, if the monitoring unit 12 detects that scratches have appeared on one of the door leafs 20 or components of it, then it is determined that the maintenance state and the state of wear of the door leaf 20 have deteriorated. Further, it is determined that the respective door leaf 20 is not installed properly anymore and a service technician is informed by a notification to his mobile device that the door system 14 needs service.

FIGS. 3, 4 and 5 show further embodiments of a system 10 according to the invention, which correspond to the first embodiment as described above. In the following, only the differences are described and the same and functionally the same components are labeled with the same reference number.

FIG. 3 shows a second embodiment of the system 10, wherein the door 16 of the automatic door system 14 is a swing door having one door leaf 20. The camera 40 is mounted above the door leaf 20.

FIG. 4 shows a third embodiment of the system 10, wherein the door 16 of the automatic door system 14 is also a swing door but having two door leafs 20. Two cameras 40 are provided, wherein each one of the cameras 40 is mounted above one of the door leafs 20.

FIG. 5 shows a fourth embodiment of the system 10, wherein the door 16 of the automatic door system 14 is a foldable door. The camera 40 is mounted above the middle of the door 16.

FIG. 6 shows a fifth embodiment of the system 10, wherein the door 16 of the automatic door system 14 is a revolving door. The camera 40 is mounted above the entrance to the door 16.

1. Method for monitoring an automatic door system (14) using a monitoring unit (12), wherein the door system (14) comprises at least one door component (18), in particular a movable door leaf (20), at least one drive unit (38) for actuating the at least door component (18), a camera (40) and a control unit (36) for controlling the drive unit (38) based on the recordings generated by the camera (40), wherein the method comprises the following steps:
capturing at least one recording by the camera (40), wherein the recording includes at least parts of the door component (18),
transmitting the recording to the monitoring unit (12),
determining a state of the door system (14) based on the transmitted recording by the monitoring unit (12), and
determining a remaining useful life and/or a need for servicing the door system (14) based on the determined state of the door system (14).

2. Method according to claim 1, characterized in that the camera (40) is an integral part of the safety functionality of the door (16) and monitors the track of the door (16), particularly of the door leaf (20) and/or the camera (40) is a camera based opening sensor.

3. Method according to claim 1, characterized in that, if a remaining useful life below a predetermined threshold and/or a need for servicing the door system (14) has been determined by the monitoring unit (12), measures are taken or initiated by the monitoring unit (12), in particular the control unit (36) is ordered to change the actuation of the door system (14) to increase the remaining useful life and/or service of the door system (14) is initiated, for example by informing a service technician.

4. Method according to claim 1, characterized in that, if a remaining useful life below a predetermined threshold and/or a need for servicing the door system (14) has been determined by the monitoring unit (12), measures are taken or initiated by the monitoring unit (12), in particular the control unit (36) is ordered to change the actuation of the door system (14) to increase the remaining useful life and/or service of the door system (14) is initiated.

5. Method according to claim 1, characterized in that the at least one door component (18) is a movable door leaf (20) and/or a protective wing (22), in particular wherein the door system (14) comprises two or more movable door leafs (20) and the recording includes the door leafs (20) at least partially, in particular entirely.

6. Method according to claim 1, characterized in that the state of the door system (14) is a state of wear, a maintenance state and/or the presence of an irregularity.

7. Method according to claim 6, characterized in that the state of wear includes damages of the door component (18) and/or parts of the door component (18), in particular damages, detachment, misplacement and/or changes to seals (26), brushes (28), profiles (30), window panes (32), protection devices (24) and/or panels (34) of the door system.

8. Method according to claim 6, characterized in that the maintenance state includes the clearance, the presence of a protective wing (22), the position of the protective wing (22), the presence of a protection device (24), the position of the protection device (24), the presence of a protective profile, and/or the position of the protective profile.

9. Method according to claim 6, characterized in that an irregularity is the absence of the door component (18) in the recording, vibrations during movement of the door (16) and/or of the door component (18), an emergency stop, side pressure induced door leaf bending and/or an obstacle (43) in a track of the door (16) or at the ground.

10. Method according to claim 1, characterized in that the recording is a recording of a single image, a series of images and/or a video sequence.

11. Method according to claim 1, characterized in that the state of the door system (14) is determined by a comparison of the recording with a reference recording, in particular wherein the reference recording has been captured immediately after the first installation of the door system (14), after a major service of the door system (14), recorded at a previous point in time, is generated by the manufacturer and/or has been generated on the basis of many different recordings that have been captured with a certain time difference.

12. Method according to claim 1, characterized in that the state of the door system (14) is determined by comparing multiple images of the recording with one another, in particular by comparing a plurality of images of a video sequence.

13. Method according to claim 1, characterized in that the state of the door system (14) is determined by the following steps:
recognizing an object in the images of the recording and its coordinate within each image;
determining the change of coordinates of the object over the course of at least two images, and optionally
determining a vibration, movement and/or strain of the object by comparing the coordinates of the object of each image, in particular wherein the presence of an irregularity, like an obstacle in the track, is determined if the movement of the object is non-uniform and/or if vibrations are present.

14. Method according to claim 1, characterized in that the door systems (14) comprises at least one sensor (42) transmitting at least one measurement value to the monitoring unit (12), wherein the state, the remaining useful life and/or the need for servicing the door system (14) is also determined based on the at least one measurement value.

15. Method according to claim 14, characterized in that the sensor (42) is a vibration sensor, a acceleration sensor for determining the transversal acceleration on the door leaf (20) and/or a microphone for airborne noise and/or structure-borne noise.

16. Method according to claim 1, characterized in that the drive unit (38) and/or the control unit (36) measures at least one further measurement value and transmits the at least one further measurement value to the monitoring unit (12), wherein the at least one further measurement value is used for determining the state, the remaining useful life and/or the need for servicing the door system (14), in particular wherein the at least one further measurement values is one or more value of the following group: motor current; temperature of the motor and/or of a battery of the drive unit (38); health of the battery of the drive unit (38); voltage patterns on the motor operator of the drive unit (38); power consumption for performing a full closing cycle; change in mass inertia of the door (16); usage patterns and kinematics resulting from usage patterns; exceptional usages, in particular emergency stops; and signals of a communication bus.

17. Method according to claim 1, characterized in that the monitoring unit (12) receives further information, wherein the information is used for determining the state, the remaining useful life and/or the need for servicing the door system (14), in particular wherein the further information include weather data, like wind speed, wind direction, humidity and/or ambient temperature; information about services performed at the door system (14); and/or information from a system of the building the door system (14) in installed in, for example a temperature of an air conditioning system of the building.

18. Method according to claim 1, characterized in that the monitoring unit (12) determines the cause for the state of the door system (14), in particular the deterioration of the state, in particular wherein the cause may be severe and/or enduring weather conditions, vandalism, misuse, emergency stops, side pressure induced door leaf bending and/or accidents.

19. Method according to claim 1, characterized in that the determination of the state of the door system (14), of the remaining useful life and/or of a need for servicing is performed by a deterministic algorithm, a machine learning algorithm, a support vector machine and/or a trained artificial neural network of the monitoring unit (12).

20. Method according to claim 1, characterized in that the determination of the cause for the state of the door (16) is performed by a deterministic algorithm, a machine learning algorithm, a support vector machine and/or a trained artificial neural network of the monitoring unit (12).

21. Method according to claim 19, or 20, characterized in that the artificial neural network is trained using training data, wherein the training data comprises, for various training situations, input data of the same type and structure as the data which is fed to the artificial neural network during regular operation of the door system (14), and information about the expected correct output of the artificial neural network for the training situations; the training comprises the following training steps:
feed forward of the input data through the artificial neural network;
determining an answer output by the artificial neural network based on the input data,
determining an error between the answer output of the artificial neural network and the expected correct output of the artificial neural network; and
changing the weights of the artificial neural network by back-propagating the error through the artificial neural network, in particular wherein the input data includes recordings generated by the camera (40), the at least one measurement value of the at least one sensor (42), of the control unit (36) and/or of the drive unit (38), and/or further information receivable by the monitoring unit (12); wherein the information about the expected correct output includes the state of the door system (14), the remaining useful life and/or the need for servicing the door system (14) in the training situations; and wherein the answer output includes the state of the door system (14), the remaining useful life and/or the need for servicing determined based on the input data.

22. System comprising a monitoring unit (12) and an automatic door system (14) having at least one door component (18), in particular a movable door leaf (20), at least one drive unit (38) for actuating the at least door component (18), a camera (40) having a field of view including at least parts of the door component (18), and a control unit (36) for controlling 31 the drive unit (38) based on the recordings generated by the camera (40), wherein the system (10) is configured to carry out a method according to claim 1, in particular wherein the monitoring unit (12) is part of the door system (14), for example the control unit.
